(19) United States
(12) Patent Application Publication
(10) Pub. No.: US 2010/0091186 A1
(43) Pub. Date: Apr. 15, 2010

(54) Display System and Receiving Apparatus

(75) Inventor: Haruki TAKATA, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Consumer Electronics Co., Ltd., Tokyo (JP)

(21) Appl. No.: 12/576,181

(22) Filed: Oct. 8, 2009

(30) Foreign Application Priority Data
Oct. 9, 2008 (JP) 2008-262347

(51) Int. Cl. H04N 7/01

(52) U.S. Cl. 348/452; 348/E07.003; 348/569

(57) ABSTRACT

A flame rate is up-converted two times by an STB (Set-Top Box) and a display apparatus which have a frame rate conversion function respectively. Thereby, the flame rate is converted to approximately “n” times higher frame rate which is a driving frequency of a display device used in a display apparatus. The display apparatus and the STB respectively have an image quality correcting circuit and an OSD (On-Screen Display) circuit which are selected to be used and displayed according to the display apparatus connected. In such configurations, the STB can be commonly utilized with respect to various sorts of display apparatuses having a liquid crystal display panel, a PDP (Plasma Display Panel), and other types of display panels.

### INCORPORATION BY REFERENCE

The present application claims priority from Japanese application JP 2008-262347 filed on Oct. 9, 2008, the content of which is hereby incorporated by reference into this application.

### BACKGROUND OF THE INVENTION

1. Field of the Invention

The present invention is related to a display system which mutually connects a display apparatus for displaying thereon a moving picture of a moving picture signal to a signal processing apparatus for performing a moving picture processing operation of the moving picture signal so as to utilize the display apparatus and the signal processing apparatus and also, related to a receiving apparatus.

2. Description of the Related Art

Conventionally, such display systems capable of performing moving picture display operations are known in the technical fields, while in these display systems, display apparatuses (so-called “monitors”) capable of displaying thereon moving pictures (images) in response to inputted moving picture signals are separately provided with signal processing apparatuses functioning as signal output apparatuses, and the display apparatuses are connected to the signal processing apparatuses by employing, for instance, cables, or wireless communication manners, instead of one-integral type moving picture display apparatuses in which moving pictures of received television broadcasting programs (will also be simply abbreviated as “program moving pictures” hereinafter) and/or external input moving pictures are displayed on display devices built in these one-integral type moving picture display apparatuses. The above-described display apparatuses of the known display systems are equipped with flat surface type display panels functioning as display devices, such as a liquid crystal display panel, a plasma display panel (will be abbreviated as “PDP” hereinafter), an organic EL display panel (will be abbreviated as “OLED” panel hereinafter), and a filed emission display panel (will be abbreviated as “FED” panel hereinafter). While the above-described signal processing apparatuses of the known display systems contain tuners for receiving program signals of television broadcasting programs, and input signal selecting switches for selectively switching the program signals of the television broadcasting programs received by the tuners and external input moving picture signals entered from external sources (not shown), the signal processing apparatuses perform predetermined signal processing operations with respect to moving picture signals outputted from the input signal selecting switches so as to output the processed moving picture signals to the display apparatuses. The above-described structural arrangements may have merits of improvements in elasticity and flexibility with respect to slim structures of the display apparatuses and installation locations of these display systems. These conventional techniques of these display systems have been described in, for instance, JP-A-2005-086721. It should be understood that a signal processing apparatus will also be referred to as a “set-top box” hereinafter, and will be simply abbreviated as “STB” hereinafter.

In addition, as technical ideas capable of improving image qualities of displayed moving pictures, motion compensating type frame rate converting techniques capable of converting frame rates (frame frequencies) of input moving picture signals into desirable frame rates thereof by utilizing amounts of motion and motional directions (namely, so-called “motion vectors”) of objects contained in moving pictures (will be referred to as “frame rate conversion” hereinafter) are known in the technical field, for instance, JP-A-2006-165602.

### SUMMARY OF THE INVENTION

Now, in such a case that a frame rate converter is arranged only on the side of a signal processing apparatus (namely, STB) functioning as a signal output apparatus, for example, if a frame rate is converted from 60 Hz to 120 Hz (namely, double speed frame rate conversion), then an amount of data transferred from the signal processing apparatus to a display apparatus becomes huge, and if a real-time display operation is considered, then a data transfer speed is increased, so that spurious radiation (electromagnetic interference) may occur from a connection cable. Also, since the amount of data to be transferred is considerably increased, the data transfer speed is restricted based upon the transfer band characteristic of the connection cable. As a result, there is another risk that the real-time display operation cannot be realized on the display apparatus. Furthermore, if moving picture data is transmitted from the signal processing apparatus (STB) to the display apparatus in a wireless communication manner, instead of the connection cable, then an amount of transmitted moving picture data becomes huge, so that the transmission amount of the moving picture data is restricted due to the transmission range characteristic by the wireless communication manner. Accordingly, there is such a risk that the transmission speed of the moving picture data required for the real-time display operation may not be realized.

On the other hand, in such a case that a frame rate converter is arranged only on the side of a display apparatus and the frame rate converter is not arranged on the side of a signal processing apparatus (namely, STB), since the frame rate converter is not provided on the side of the signal processing apparatus (STB), if such a signal processing apparatus (STB) having no frame rate converter is combined with another display apparatus having no frame rate converter, then an image process operation can be hardly carried out in a proper manner. For instance, in a display apparatus equipped with a PDP (Plasma Display Panel) functioning as a display device different from a liquid crystal display panel, even when such a double speed frame rate conversion from 60 Hz to 120 Hz is not carried out, the display apparatus equipped with the display panel of PDP can display thereon moving pictures in a sufficiently high image quality. As a result, there is no reason that the frame rate converter is necessarily employed on the side of such a PDP display apparatus. In order that the signal processing apparatus (STB) is combined with another display apparatus without having such a frame rate converter, the frame rate converter must be provided on the side of the signal processing apparatus (STB).

The present invention has been made of solve the above-described problems, and has an object to provide a display system capable of improving a user friendly characteristic thereof by arbitrarily combining a signal processing apparatus (namely, Set-Top Box) with such display apparatuses that sorts and technical specifications of display devices employed in these display apparatuses are different from each other.

To achieve the above-described object, a display system, according to an aspect of the present invention, is featured by such a display system comprising: a signal processing apparatus for receiving a moving picture signal so as to process the received moving picture signal; and a display apparatus for displaying thereon the moving picture signal processed by the signal processing apparatus; in which the signal processing apparatus includes: a first frame rate converting unit which generates an interpolated frame based upon motional information of the moving picture signal, and inserts the formed interpolated frame into a frame series of the received moving picture signal so as to convert a frame rate of the received moving picture signal; and in which the display apparatus includes: a second frame rate converting unit which generates an interpolated frame based upon motional information of the moving picture signal, and inserts the formed interpolated frame into the frame series of the received moving picture signal so as to convert the frame rate of the moving picture signal converted by the first frame rate converting unit.

In accordance with the above-described structural arrangements, the signal processing apparatus can be arbitrarily combined with the display apparatuses in which the sorts and technical specifications of the display devices employed therein are different from each other, so that the user friendly characteristics of the display system and the receiving apparatus can be improved.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram for schematically showing a display system, according to a first embodiment of the present invention, in such a case that a display apparatus operable at a frame rate two times higher than a frame rate of an input signal is connected to an STB.

FIG. 2 is a diagram for schematically representing a display system, according to a second embodiment of the present invention, in such a case that a display apparatus operable at a frame rate of an input signal is connected to the STB.

FIG. 3 represents one structural example as to ID information employed in the display systems of the first and second embodiments.

### DESCRIPTION OF THE EMBODIMENTS

Referring now to drawings, a description is made of various sorts of embodiments according to the present invention. It is so assumed that structural elements shown in respective drawings, to which the same reference numerals have been applied, have either the same functions or the same operations, and therefore, duplicated explanations thereof will be omitted.

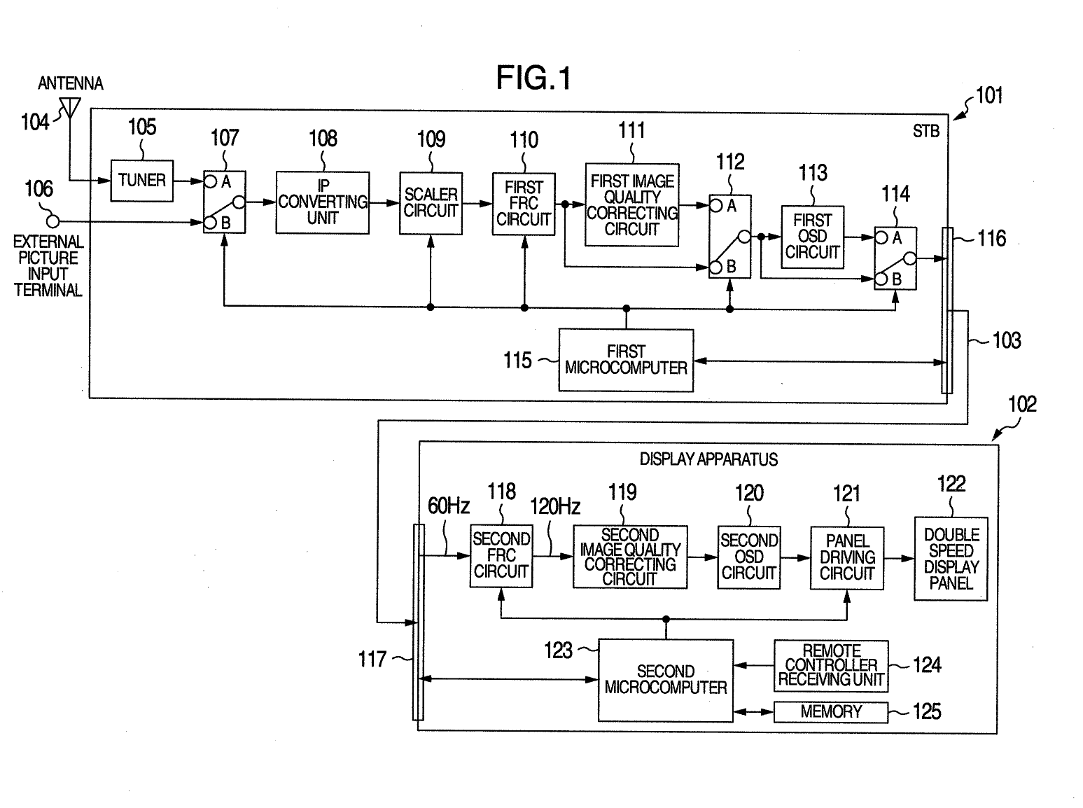

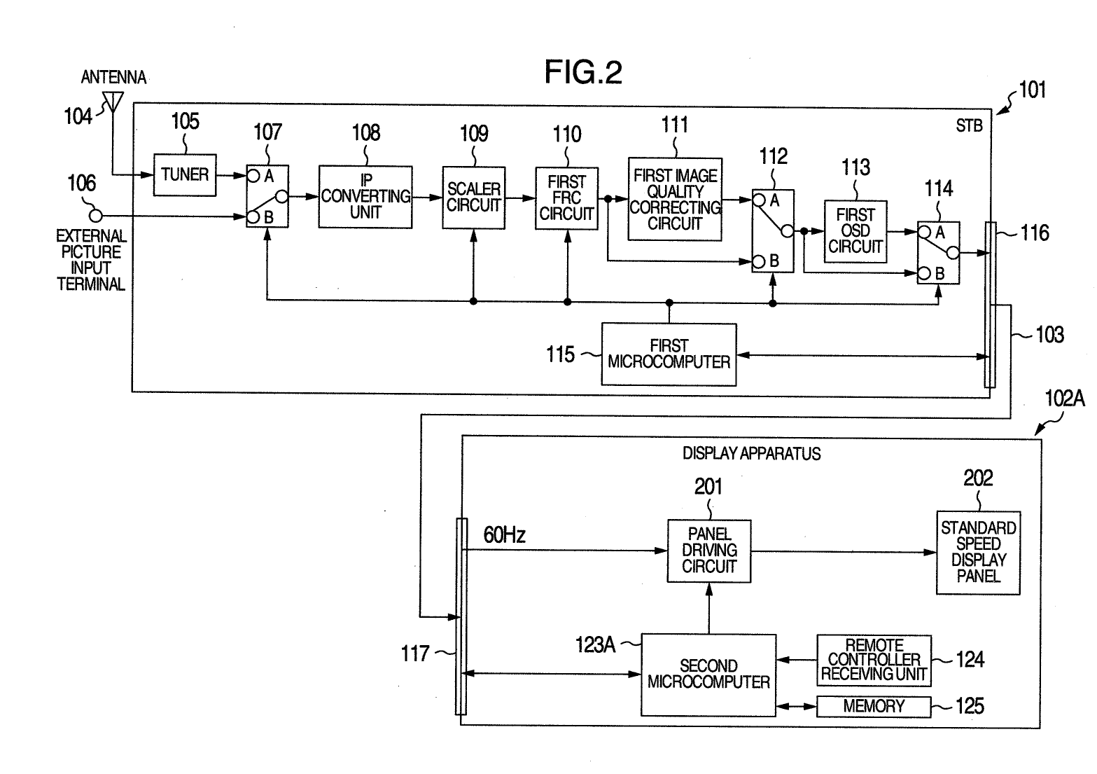

Referring to FIG. 1 and FIG. 2, a description is made of an embodiment as to display systems according to the present invention. In the embodiment, operations of the above-described display systems are different from each other, depending upon differences in sorts and technical specifications of display devices which are employed in display panels built in display apparatuses. FIG. 1 is a diagram for schematically showing one display system, according to a first embodiment of the present invention, in such a case that a display apparatus operated at a frame rate which is two times higher than a frame rate of an inputted moving picture signal is connected to an STB (Set-Top Box). FIG. 2 is a diagram for schematically representing another display system, according to a second embodiment of the present invention, in such a case that a display apparatus operated at a frame rate equal to a frame rate of an inputted moving picture signal is connected to the STB.

Firstly, a description is made of an arrangement and operation of such a display system that a display apparatus is connected to an STB with reference to FIG. 1, while the display apparatus is operated at a frame rate which is two times higher than a frame rate of an inputted moving picture signal. In FIG. 1, it is so assumed that a display device (flat surface type display panel) which is employed in a display panel built in the display apparatus is a liquid crystal display panel which is driven at a frame rate of 120 Hz. However, the above-described display device is not limited only to this liquid crystal display panel driven at the frame rate of 120 Hz.

As apparent from FIG. 1, the display system of the first embodiment is arranged by an STB 101 functioning as a signal output apparatus, a display apparatus 102, and a cable 103 which connects the STB 101 to the display apparatus 102. In the case that a frame rate of a moving picture signal of a received television broadcasting program and/or a frame rate of an entered input moving picture signal is slower than a first frame rate, the signal output apparatus (namely, STB 101) converts the above-described moving picture signal having the slower frame rate into a moving picture signal having the first frame rate. The display apparatus 102 converts the frame rate (namely, first frame rate) of the moving picture signal outputted from the STB 101 into such a frame rate (namely, second frame rate) which is two times higher than the first frame rate, and then, displays thereon the moving picture signal having the converted second frame rate. In the first embodiment, although the STB 101 is connected to the display apparatus 102 by employing the cable 103, the present invention is not limited only to the cable connecting manner. Apparently, the STB 101 may be alternatively connected to the display apparatus 102 based upon a wireless connecting manner such as a wireless communication manner and an optical communication manner. The above-described STB 101 and display apparatus 102 have contained separately independent housings, respectively. As apparent from the foregoing description, the STB 101 may be alternatively stored in the display apparatus 102 in a detachable manner.

Since the STB 101 has contained a tuner in order to receive television broadcasting programs, the STB 101 is capable of receiving any one of an analog ground-wave broadcasting program such as the standard NTSC signals, an analog BS broadcasting program, a digital BS/CS broadcasting program, and a digital ground-wave broadcasting program. Otherwise, the STB 101 is capable of receiving an arbitrary combination of the above-explained broadcasting programs, or all these broadcasting programs. Alternatively, the STB 101 may build therein a hard disk drive (HDD) and/or a digital video player/recorder (so-called “DVD” player/recorder). In addition, the STB 101 may be alternatively equipped with input and output terminals for video signals and component signals.

On the other hand, as a display panel to be built in the display apparatus 102, a flat surface type display panel such as a liquid crystal display panel, a PDP (Plasma Display Panel), an OLED (Organic EL display panel) panel, or an FED (Field Emission Display) panel may be employed. It should be understood that as previously described, in FIG. 1, it is so assumed that such a liquid crystal display panel is employed as the display device, while the liquid crystal display panel is operated at a frame rate (for instance, 120 Hz) which is, for example, two times higher than a frame rate of an inputted moving picture signal.

Also, the cable 103 has contained therein at least a video line, a sound line, and a bidirectional communication line. The video line and the sound line have been employed so as to supply either a digital type moving picture signal or an analog type moving picture signal, and a sound signal, which are derived from the STB 101, to the display apparatus 102. The bidirectional communication line has been employed so as to transmit a control signal derived from the STB 101 to the display apparatus 102, and further, to transmit identification information (ID information, will be explained later) of the display apparatus 102, and a remote control signal (not shown) received by the display apparatus 102. In other words, as to a relationship established between the STB 101 and the display apparatus 102, the STB 101 corresponds to a master which controls the display apparatus 102, whereas the display apparatus 102 corresponds to a slave which is controlled by the STB 101.

Next, a description is made of detailed structures and detailed operations of the respective structural units. For the sake of simple explanations, assuming now that a digital broadcasting program is received by the tuner 105 and a digital moving picture signal is inputted from an external source (not shown), a description will be made of processing operations specific to moving picture signals thereof, and a description as to processing operations specific to sound signals thereof will be omitted. As apparent from the foregoing description, when an analog moving picture signal is inputted, the inputted analog moving picture signal may be merely converted into a corresponding digital moving picture signal by an A/D (Analog-to-Digital) converter (not shown), and then, the converted digital moving picture signal may be merely utilized.

Firstly, a description is made of a detailed structure and a detailed operation with respect to the above-described STB 101.

For instance, a television broadcasting signal is received by an antenna 104, and thereafter, a desirable channel of the received television broadcasting signal is tuned by the tuner 105. The tuner 105 is equipped with a digital unit (not shown) which contains a digital tuner unit for receiving the digital television broadcasting signal, and a decoder. In this case, since the digital television broadcasting signal has been compressed/decoded based upon the MPEG-2 format, or the like, the tuner 105 decodes the MPEG-2 formatted digital television signal received/demodulated by the digital tuner unit by operating the decoder so as to output the decoded MPEG-2 formatted digital television broadcasting signal as a digital moving picture signal to a contact “A” of a first switch 107.

On the other hand, a digital moving picture signal outputted from an external moving picture output appliance such as a DVD player and a hard disk recorder is entered to an external moving picture input terminal 106 via a digital interface cable, for instance, an HDMI (High Definition Multimedia Interface) cable. The digital moving picture signal entered to the above-explained external moving picture input terminal 106 is supplied to another contact “B” of the first switch 107.

In response to a display mode (for instance, television broadcast display mode, external input display mode etc.) selected by a user, the first switch 107 is employed in order to select one desirable moving picture signal source from a plurality of moving picture signal sources such as an external input moving picture signal entered from the external moving picture input terminal 106 and a moving picture signal of a television broadcasting program received by the tuner 105, and then, to output the selected moving picture signal of the desirable moving picture signal source. The above-described selection of the moving picture signal of one desirable moving picture signal source by the first switch 107 is controlled based upon a control signal supplied from a first so-called “MICON” 115 corresponding to a control circuit. While operations of the respective structural units of the STB 101 in response to the respective display modes will be discussed later, a first description is made of basic operations as to the respective structural units. It should also be noted that the above-described “MICON” is an abbreviated term of a microcomputer functioning as an operation control unit.

The moving picture signal of the desirable moving picture signal source selected by the first switch 107 is inputted to an IP converting circuit 108. In such a case that a moving picture signal inputted from the first switch 107 is an interlaced scanning type moving picture signal, the IP converting circuit 108 converts the interlaced scanning type moving picture signal into a progressive scanning type moving picture signal. It should also be noted that when a moving picture signal entered from the first switch 107 is a progressive scanning type moving picture signal, the IP converting circuit 108 directly outputs the inputted progressive scanning type moving picture signal. The moving picture signal converted into the progressive scanning type moving picture signal by the IP converting circuit 108 is inputted to a scaler circuit 109. The scaler circuit 109 performs a control operation under control of the first microcomputer 115 in such a manner that a pixel number of the inputted moving picture signal along a horizontal direction and/or a vertical direction is made coincident with a display format of the display apparatus 102, if necessary. The above-explained process operation for controlling the pixel number of the inputted moving picture signal will be referred to as a “scaling process operation” hereinafter. The moving picture signal scaling-processed by the scaler circuit 109 is entered to a first frame rate converting circuit (will be referred to as “first FRC circuit” hereinafter; symbol “FRC” indicates Frame Rate Conversion) 110.

The first FRC circuit 110 is such an element capable of performing the above-described motion compensating type first frame rate converting process operation with respect to the moving picture signal entered from the scaler circuit 109 under control of the first microcomputer 115. In the first embodiment, the first FRC circuit 110 is equipped with a function mode (will be referred to as “50/60 Hz frame rate conversion mode” hereinafter), another function mode (will be referred to as “24/60 Hz frame rate conversion mode” hereinafter), and the like. In the 50/60 Hz frame rate conversion mode, in such a case that a frame rate of a moving picture signal entered from the scaler circuit 109 is lower than, or equal to 60 Hz corresponding to the first frame rate, for example, is equal to 50 Hz, the first FRC circuit 110 converts the above-described frame rate of 50 Hz into such a frame rate of 60 Hz corresponding to the first frame rate by considering motion of the moving picture. In the 24/60 Hz frame rate conversion mode, in such a case that a frame rate of a moving picture signal entered from the scaler circuit 109 is 109 is equal to, for instance, 24 Hz, the first FRC circuit 110 converts the above-described frame rate of 24 Hz into such a frame rate of 60 Hz corresponding to the first frame rate by considering motion of the moving picture.

Concretely speaking, the first FRC circuit 110 produces an interpolated frame based upon the inputted moving picture signal, and then converts the frame rate of the inputted moving picture signal by combining the interpolated frame with an original frame series contained in the inputted moving picture signal. In this case, the first FRC circuit 110 detects a motional direction of an object contained in a moving picture from at least two frames within original frames contained in a moving picture signal to be inputted, and generates an interpolated pixel based upon pixel data of the two relevant frames which are present on a straight line indicative of this detected motional direction. Thereafter, since generating of this interpolated pixel is carried out with respect to all pixels which will construct an interpolated frame, the first FRC circuit 110 generates such an interpolated frame which is inserted between the relevant two frames. As previously explained, the interpolated frames which have been formed in the above-described generating manner are combined with the original frame of the inputted moving picture signal.

For instance, in the above-explained 50/60 Hz frame rate conversion mode, since 1 sheet of interpolated frame is inserted every 5 sheets of original frame series contained in an inputted moving picture signal, the first FRC circuit 110 can convert a frame rate of this moving picture signal from 50 Hz to 60 Hz in response to motion of the moving picture thereof. Alternatively, the frame rate of the above-explained moving picture signal may be alternatively converted from 50 Hz to 60 Hz by replacing 4 sheets of the original frames contained in the moving picture signal by 5 sheets of the interpolated frames.

Also, a cinema signal having a frame rate of 24 Hz may be converted into a cinema signal having a frame rate of 60 Hz. For example, in the case that an original frame series is constituted by a frame “A”, a frame “B”, and a frame “C”, in the above-described 24/60 Hz frame rate conversion mode, the first FRC circuit 110 generates as interpolated frames such interpolated frames “a1”, “b1”, “b2”, “c1”, - - - , which have been produced by considering motion from a plurality of original frames (for example, two original frames). Then, these interpolated frames “a1”, “b1”, “b2”, “c2”, - - - , are added to the original frame series in order to form a new frame series having an array of A, a1, B, b1, b2, C, c1, - - - , so that the first FRC circuit 110 converts the frame rate from 24 Hz to 60 Hz. Since the frame rate of the original frame is converted in accordance with the above-explained converting manner, the motion can be smoothed by reducing dithering feelings of the motion which appear after the frame conversion has been performed, as compared with that of the frame repeat.

It should also be noted that since detailed contents as to the above-explained generating operations of the interpolated pixels and the interpolated frames have been described in JP-A-2006-165602, no more detailed explanation thereof will be omitted. It should also be understood that while the frame rate of the inputted moving picture signal is converted into the frame rate of 60 Hz corresponding to the first frame rate in the first FRC circuit 110, the converted frame rate of 60 Hz corresponds to such a frame rate at which a moving picture can be displayed without producing a flicker phenomenon. Generally speaking, a flat surface type display panel capable of displaying thereon a television broadcasting program is driven at this frame rate of 60 Hz. Under such a circumstance, the first frame rate of 60 Hz may be referred to as a “standard speed frame rate.” Accordingly, it is so assumed that the first frame rate will also be referred to as the standard speed frame rate.

The moving picture signal whose frame rate has been converted into the first frame rate (namely, 60 Hz in this example) by the first FRC circuit 110 is processed by a first image quality correcting circuit 111 based upon a predetermined image quality correction, and thereafter, the image-quality-corrected moving picture signal is entered to one contact “A” of a second switch 112, and the first-mentioned moving picture signal is directly entered to the other contact “B” of the second switch 112. The first image quality correcting circuit 111 performs various sorts of image quality correcting process operations with respect to the inputted moving picture signal, and then, outputs the image-quality-corrected moving picture signal to the contact “A” of the second switch 112. As the above-described moving picture quality correcting process operations, for instance, a color correcting process operation, a contrast correcting process operation, a gamma correcting process operation, and other process operations are carried out by the first image quality correcting circuit 111. A selection of a moving picture signal by the second switch 112 is controlled in response to a control signal supplied from the first microcomputer 115 corresponding to the control circuit. The moving picture signal selected by the second switch 112 is entered through a first OSD (On-Screen Display) circuit 113 to one contact “A” of a third switch 114, and also, is directly inputted to the other contact “B” of the third switch 114. The first OSD circuit 113 superimposes a predetermined OSD signal with respect to the inputted moving picture signal, and then, outputs the OSD-superimposed moving picture signal to the contact “A” of the third switch 114, while the predetermined OSD signal corresponds to a graphic signal in order to display a moving picture of the moving picture signal on the display apparatus 102. Also, a selection of a moving picture signal by the third switch 114 is controlled in response to a control signal supplied from the first microcomputer 115 corresponding to the control circuit. The moving picture signal outputted from the third switch 114 is supplied via a first connector 116 and the cable 103 to the display apparatus 102, while the cable 103 is connected to the first connector 116 in a detachable manner.

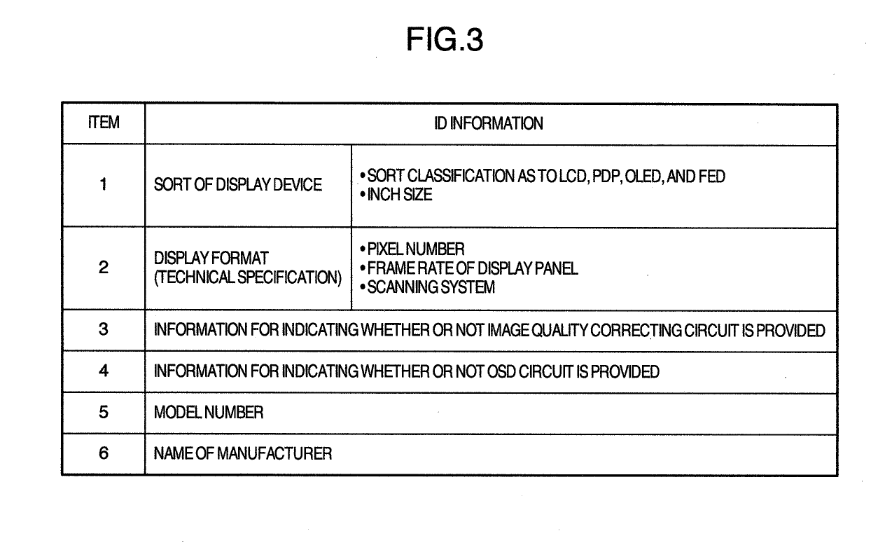

The first microcomputer 115 operable as an operation control unit having control functions of the respective circuits employed in the STB 101 performs control operations with respect to the first switch 107, the scaler circuit 109, the first FRC circuit 110, the second switch 112, the third switch 114, and the like. Also, the first microcomputer 115 is communicated via a communication line (not shown) contained in the cable 103 with a second microcomputer 123 (will be discussed later) in a bidirectional manner, which is mounted on the display apparatus 102, in order to transmit control commands and to receive a remote control signal and ID information (detailed content thereof will be explained later with reference to FIG. 3) corresponding to identification information, and the like, while the remote control signal is received by the display apparatus 101. The above-described ID information is transmitted from the display apparatus 102 to the STB 101 corresponding to a control center so as to identify, for instance, a sort of a display device, a technical specification thereof, and information for indicating whether or not an image quality correcting circuit and an OSD circuit are employed. As apparent from the foregoing description, in order to realize the above-described control operations of the first microcomputer 115 and the second microcomputer 123, a memory 125 for storing thereinto the ID information and the like, a working memory (not shown), and a ROM (Read-Only Memory; not shown) must be previously provided. The working memory is employed in order to perform operation controls, and the ROM has previously stored thereinto programs capable of executing predetermined process operations.

It should also be understood that although the first microcomputer 115 has been equipped with the control circuit for controlling the respective structural units of the STB 101 and the communication circuit for communicating with the display apparatus 102 in the above explanation, the first microcomputer 115 may be alternatively arranged by being divided into the control circuit and the communication circuit in order to reduce the operation control function thereof.

Then, the first microcomputer 115 judges, for instance, a sort and a technical specification of a display device for constructing the display panel 122 to be built in the display apparatus 102, and also judges whether or not an image quality correcting circuit, an OSD circuit, and the like are provided based upon the ID information received from the display apparatus 102. Based upon a result of the above-described judgement, the first microcomputer 115 controls the scaler circuit 109, the second switch 112, and the third switch 114.

Next, a description is made of a detailed structure and a detailed operation of the display apparatus 102.

A moving picture signal (having frame rate of 60 Hz) entered via the cable 103 and a second connector 117 is inputted to a second FRC circuit 118.

In the second FRC circuit 118, a motion compensating type frame rate converting process operation is furthermore carried out with respect to the inputted moving picture signal. The second FRC circuit 118 has the below-mentioned technical difference from the above-described first FRC circuit 110. That is, the first FRC circuit 110 converts the frame rate from 50 Hz to 60 Hz, or from 24 Hz to 60 Hz, whereas the second FRC circuit 118 converts the frame rate from 60 Hz (first frame rate, namely standard speed frame rate) to 120 Hz (second frame rate) which fits with a frame rate of a display device (namely, liquid crystal display panel in this case), namely, the second FRC circuit 118 performs a double speed frame rate converting process operation.

If the first FRC circuit 110 of the STB 101 is equipped with the double speed frame rate conversion function so as to perform the double speed frame rate converting process operation, then the below-mentioned risks may occur, as previously described in the background. That is, an amount of data transferred from the STB 101 via the cable 103 to the display apparatus 102 becomes huge, and if a real-time display operation is considered, then a data transfer speed is increased, so that spurious radiation (electromagnetic interference) may occur from the cable 103. Apparently, since the data transfer speed is restricted based upon the transfer band characteristic of the cable 103, there is another risk that the real-time display operation cannot be realized. As a consequence, in the first embodiment, the double speed frame rate converting process operation is carried out in the second FRC circuit 118 of the display apparatus 102.

In this frame rate converting process operation executed in the second FRC circuit 118, the frame rate is increased by 2 times (namely, 120 Hz) in such a manner that an interpolated frame is inserted every 1 frame within frame series contained in the moving picture signal entered via the second connector 117. It is so assumed that a generating method for generating interpolated pixels and interpolated frames in the second FRC circuit 118 is similar to the generating method of the first FRC circuit 110.

An output signal derived from the second FRC circuit 118 is entered to a second image quality correcting circuit 119 so as to perform various sorts of the below-mentioned image quality correcting process operations. That is, for instance, a color correcting process operation, a contrast correcting process operation, a gamma correcting process operation, and other process operations are carried out in the second image quality correcting circuit 119. Then, the image-quality-corrected moving picture signal is inputted to a second OSD circuit 120. The second OSD circuit 120 superimposes a predetermined OSD signal with respect to the moving picture signal entered from the second image quality correcting circuit 119, and then, outputs the OSD-superimposed moving picture signal to a panel driving circuit 121, while the predetermined OSD signal corresponds to a graphic signal in order to display a moving picture of the moving picture signal on the display panel 122.

The panel driving circuit 121 drives the display panel 122 at such a timing which is suitable for generating a moving picture on the display panel 122 in response to the output signal from the second OSD circuit 120. As a result, an image is displayed on the display panel 122 based upon the inputted moving picture signal.

The second microcomputer 123 operable as an operation control unit having control functions of the respective circuits employed in the display apparatus 102 performs control operations with respect to the second FRC circuit 118, the panel driving circuit 121, and the like. Also, the second microcomputer 113 is communicated via the communication line (not shown) contained in the cable 103 with the first microcomputer 115 in the bidirectional manner, which is mounted on the STB 101, in order to receive control commands transmitted from the STB 101, and to transmit a remote control signal and ID information corresponding to identification information, and the like. The remote control signal is derived from a remote control unit (not shown) for performing a remote control operation, and is received by a remote control receiving unit 124 of the display apparatus 102. The above-described ID information is transmitted from the second microcomputer 123 so as to identify, for instance, a sort of a display device, a technical specification thereof, information for indicating whether or not an image quality correcting circuit and an OSD circuit are employed, and the like. As apparent from the foregoing description, in order to realize the above-described control operation of the second microcomputer 123 and the first microcomputer 115, for example, a non-volatile memory 125 for previously storing thereinto the ID information and the like, a working memory (not shown), and a ROM (Read-Only Memory; not shown) must be previously provided. The working memory is employed in order to perform operation controls, and the ROM has previously stored thereinto programs capable of executing predetermined process operations. A detailed control content based upon the above-explained ID information will be discussed later.

As previously described, in the display system of the first embodiment represented in FIG. 1, the STB 101 has been equipped with the first FRC circuit 110, the first image quality correcting circuit 111, and the first OSD circuit 113. Also, the display apparatus 102 has been equipped with the second FRC circuit 118, the second image quality correcting circuit 119, and the second OSD circuit 120. In other words, the present invention has such a feature that the similar circuits are provided in both the STB 101 and the display apparatus 102.

In such an arrangement that the first FRC circuit 110 is present in the STB 101 and the second FRC circuit 118 is present in the display apparatus 102, when a double speed frame rate converting process operation is carried out in the second FRC circuit 118 of the display apparatus 102, an image quality correcting operation is performed by the second image quality correcting circuit 119 arranged at the post stage of the second FRC circuit 118, and thereafter, an OSD processing operation is performed by the second OSD circuit 120. As a result, an optimum image quality and an optimum OSD display can be realized.

To this end, the first microcomputer 115 of the STB 101 is communicated with the second microcomputer 123 of the display apparatus 102 in order to recognize that the display apparatus 102 has contained therein an image quality correcting circuit and an OSD circuit, and also, to control the second switch 112 and the third switch 114. In other words, the first microcomputer 115 performs such a control operation that the second switch 112 selects the contact “B” thereof so as to select a moving picture signal which has not been processed by the first image quality correcting circuit 111. Also, the first microcomputer 115 of the STB 101 similarly performs such a control operation that the third switch 114 selects the contact “B” thereof in order to select the moving picture signal outputted from the second switch 112, to which the OSD processing operation has not been performed.

As previously described, in such a case of the first embodiment that the display device built in the display apparatus 102 shown in FIG. 1 is a liquid crystal display panel operable at the double speed frame rate, in the case that a frame rate of a moving picture signal of a selected moving picture signal source (namely, either moving picture signal of broadcasting program received by tuner 105 or external input moving picture signal) is, for instance, either 24 Hz or 50 Hz, the first FRC circuit 110 of the STB (signal processing apparatus) 101 converts the frame rate (24 Hz, or 50 Hz) of the above-described input moving picture signal into a first frame rate (namely, standard speed frame rate of 60 Hz), whereas the second FRC circuit 118 of the display apparatus 102 converts the first frame rate (standard speed frame rate of 60 Hz) of the moving picture signal inputted from the STB 101 into a second frame rate (namely, double speed frame rate of 120 Hz). As a result, the moving picture signal having the first frame rate (standard speed frame rate of 60 Hz) which is entered from the STB 101 to the display apparatus 102 can be converted into the moving picture signal having the second frame rate of 120 Hz (namely, double speed frame rate of 120 Hz), and thus, a moving picture of the frame-rate-converted moving picture signal can be displayed on the display panel 122 built in the above-described display apparatus 102, while the second frame rate of 120 Hz corresponds to the driving frequency of the display panel 122. As a consequence, while a blurring phenomenon (namely, feelings of “after image”) of moving pictures specifically contained in a liquid crystal display panel can be reduced so as to achieve a high image quality, there is no possibility that an amount of data transferred via the cable 103 to the display apparatus 102 is increased, and spurious radiation (electromagnetic interference) occurred from the cable 103 can be reduced. In addition, even in such a cable whose transfer speed is restricted due to the transfer range characteristic, the moving picture of the moving picture signal can be display in the real-time display mode.

Also, in the first embodiment, while the first image quality correcting circuit 111 and the first OSD circuit 113 provided in the STB 101 are not utilized, the moving picture of the inputted moving picture signal is displayed by utilizing the second image quality correcting circuit 119 and the second OSD circuit 120 contained in the display apparatus 102. As a consequence, the frame rate converting operation by the second FRC circuit 118 into the second frame rate (namely, double speed frame rate of 120 Hz) is carried out with respect to the moving picture signal having the first frame rate (namely, standard speed frame rate of 60 Hz) entered from the STB 101 to the display apparatus 102, and thereafter, the frame-rate-converted moving picture signal is corrected based upon the optimum image quality correction, so that the optimum OSD display can be realized.

In the above-described first embodiment, the description has been made of such an arrangement that the first image quality correcting circuit 111 and the first OSD circuit 113 mounted on the STB 101 are not utilized. As apparent from the foregoing explanation, alternatively, image quality correcting process operations and OSD display processing operations may be carried out in a dual mode by utilizing both the first image quality correcting circuit 111 and the first OSD circuit 113 mounted on the STB 101, and the second image quality correcting circuit 119 and the second OSD circuit 120 mounted on the display apparatus 102. For instance, the OSD display processing operation related to the STB 101 may be carried out by the first OSD circuit 113, and the OSD display processing operation related to the display apparatus 102 may be alternatively carried out. Further, in the above-explained first embodiment, the below-mentioned frame rate converting process operation has been described: That is, the display panel 122 is operable at the double speed frame rate, and the standard speed frame rate (60 Hz) of the moving picture signal entered from the STB 101 is converted into the double speed frame rate (120 Hz) by the second FRC circuit 118. However, the present invention is not limited only to the above-described frame rate converting process operation. For instance, as apparent from the gist of the present invention, the following frame rate converting process operation may be alternatively carried out: That is, if the display panel 122 is operable at a quadruple speed frame rate, then the standard speed frame rate (60 Hz) of the inputted moving picture signal may be converted into the quadruple speed frame rate by the second FRC circuit 118.

Next, referring to FIG. 2, a description is made of a display system, according to a second embodiment of the present invention, as to a structure and operation thereof in such a case that the STB 101 described in FIG. 1 is connected to a display apparatus 102A operable at a frame rate substantially equal to a frame ate of an inputted moving picture signal. It is so assumed that in FIG. 2, as a display device (flat surface type display panel) employed in a display panel 202 built in the display apparatus 102A, such a PDP (Plasma Display Panel) operable at the standard speed frame rate (namely, 60 Hz) is employed. However, the present invention is not limited only to this PDP. For example, an FED (Field Emission Display) and a liquid crystal display panel may be alternatively employed which are driven at the standard speed frame rate (60 Hz).

As apparent from FIG. 2, the display system of the second embodiment is arranged by the STB 101 functioning as a signal output apparatus, the display apparatus 102A, and a cable 103. In such a case that a frame rate of a selected moving picture signal source (moving picture signal of received television broadcasting program, external input moving picture signal etc.) is slower than the first frame rate (namely, standard speed frame rate of 60 Hz), the STB 101 converts the selected moving picture signal having the above-explained slower frame rate into a moving picture signal having the first frame rate (=60 Hz), and then, outputs such a frame-rate-converted moving picture signal having the first frame rate. The display apparatus 102A displays thereon the moving picture signal having the first frame rate (standard frame rate of 60 Hz) outputted from the STB 101 at the same frame rate (namely, standard frame rate of 60 Hz). The cable 103 connects the STB 101 to the display apparatus 102A. As a consequence, the display system of the second embodiment has the following technical different point from that of FIG. 1: That is, the display apparatus 102A employs such a display panel 202 operable at the standard speed frame rate. It should be understood that since the STB 101 and the cable 103 have the same structures as those shown in FIG. 1, duplicated explanations as to the structural elements thereof will be omitted. For the sake of convenience, such a display panel operable at the standard speed frame rate will be referred to as a “standard speed display panel” in the below-mentioned description.

Firstly, a description is made of a detailed structure and a detailed operation of the above-described display apparatus 102A.

Different from FIG. 1, a moving picture signal having the standard speed frame rate (=60 Hz) entered from the STB 101 via the cable 103 and a second connector 117 is supplied to a panel driving circuit 201, while the standard speed frame rate thereof is not converted. The panel driving circuit 201 drives the standard speed display panel 202 at such a timing suitably capable of generating a moving picture on the standard speed display panel 202 based upon the inputted moving picture signal having the standard speed frame rate (60 Hz). As a result, an image is displayed on the standard speed display panel 202 in response to the inputted moving picture signal.

Also, a second microcomputer 123A having control functions of the respective circuits employed in the display apparatus 102A performs control operations with respect to the panel driving circuit 201, and also, the second microcomputer 123A is communicated via the communication line (not shown) contained in the cable 103 with the first microcomputer 115 in the bidirectional manner, which is mounted on the STB 101, in order to receive control commands transmitted from the STB 101, and to transmit a remote control signal and ID information corresponding to identification information, and the like. The remote control signal is derived from a remote control unit (not shown) for performing a remote control operation, and is received by a remote control receiving unit 124 of the display apparatus 102A. The above-described ID information is transmitted from the second microcomputer 123A so as to identify, for instance, a sort of a display device, a technical specification thereof, information for indicating whether or not an image quality correcting circuit and an OSD circuit are employed, and the like. A detailed content as to the control operations performed based upon the above-described ID information will be discussed later.

As apparent from FIG. 2, in the display system of the second embodiment represented in FIG. 2, the STB 101 has been equipped with the first image quality correcting circuit 111 and the first OSD circuit 113, whereas the display apparatus 102A has not been equipped with an image quality correcting circuit and an OSD circuit. In the above-explained display system, the STB 101 performs an image quality correcting process operation and an OSD processing operation by employing the own first image quality correcting circuit 111 and the own first OSD circuit 113, namely, in such a case that a display apparatus has not been equipped with an image quality correcting circuit and an OSD circuit, and furthermore, the STB 101 detects such a fact that a display panel which is provided in a display panel thereof corresponds to the standard speed display panel by executing a bidirectional communication operation with respect to the above-explained display apparatus. Concretely speaking, the STB 101 processes a moving picture signal by employing the IP converting circuit 108, the scaler circuit 109, and the first FRC circuit 110, and thereafter, performs an image quality correcting process operation and an OSD processing operation with respect to the processed moving picture signal. As a result, since an optimum image quality is given to a moving picture, the STB 101 selects the contact “A” in the second switch 112 so as to select such a moving picture signal whose image quality has been corrected by the first image quality correcting circuit 111. Also, the STB 101 selects the contact “A” even in the third switch 114 so as to select such an output moving picture signal to which the OSD signal has been added by the first OSD circuit 113.

The selecting operations as to the second switch 112 and the third switch 114 are controlled by the first microcomputer 115. The first microcomputer 115 controls the second switch 112 and the third switch 114 in such a manner that the first microcomputer 115 is communicated with the second microcomputer 123A so as to acquire ID information of the display apparatus 102A and to analyze the acquired ID information, and thus, the first microcomputer 115 recognizes that the display apparatus 102A has not been equipped with the image quality correcting circuit and the OSD circuit.

As previously explained, in such a case of the second embodiment that the display device built in the display apparatus 102A shown in FIG. 2 is a standard speed display panel, in the case that a frame rate of a selected moving picture signal (namely, either moving picture signal of broadcasting program received by tuner 105 or external input moving picture signal) is, for instance, either 24 Hz or 50 Hz, the first FRC circuit 110 of the STB (signal processing apparatus) 101 converts the frame rate (24 Hz, or 50 Hz) of the above-described inputted moving picture signal into the standard speed frame rate of 60 Hz, and also, recognizes that the display apparatus 102A has not contained therein the image quality correcting circuit and the OSD circuit. Then, the STB 101 performs an image quality correcting process operation and an OSD processing operation by utilizing the first image quality correcting circuit 111 and the first OSD circuit 113 with respect to the moving picture signal whose frame rate has been converted, and thereafter, transmits the processed moving picture signal. Then, the display apparatus 102A displays thereon the inputted moving picture signal at the standard speed frame rate of 60 Hz.

As apparent from the first embodiment of FIG. 1 and the second embodiment of FIG. 2 described in the above explanations, the STB 101 is communicated with a display apparatus in a bidirectional communication manner so as to acquire such an ID information for identifying a sort and a technical specification of a display device employed in a display panel built in the above-explained display apparatus, and also for identifying whether or not an image quality correcting circuit and an OSD circuit are present. Further, the STB 101 controls the first FRC circuit 110 thereof, the image quality correcting circuit, the OSD circuit, and the like based upon the acquired ID information in order to perform an optimum image quality correcting process operation, so that an optimum OSD display operation can be carried out. In other words, in accordance with the first and second embodiments, since the same STB can be combined with various sorts of display apparatuses in which driving frame rates of display panels thereof are different from each other, plural sets of STBs which are exclusively designed for these display apparatuses are no longer developed. As a result, a total number of STB developing staffs and a total developing cost can be suppressed, so that profits can be improved.

In this case, a description is made of one example as to a detailed content of the ID information to be stored in a microcomputer. FIG. 3 represents one example of the ID information. As shown in the drawing, the above-described ID information contains the below-mentioned various sorts of information: (1) a sort of display device which is employed in a display panel; (2) a display format (technical specification) of the display device; (3) information for indicating whether or not an image quality correcting circuit is provided; (4) information for indicating whether or not an OSD circuit is provided; (5) a model number of the display panel; and (6) a name of manufacturer. The sort of display device defined in the item (1) contains classification information for classifying that the relevant display device corresponds to a liquid crystal display (LCD) panel, a PDP, an OLED, or an FED; and further, inch size information indicative of a panel size. The display format defined in the item (2) contains such technical specifications of the display panel as to a pixel number, a panel frame rate, and a scanning system (information for indicating that scanning system corresponds to interlaced scanning system, or non-interlaced scanning system).

A description is made of one example as to a method for acquiring the above-described ID information. While the display apparatus 102 (or 102A) is equipped with a memory 125 for storing thereinto the ID information, the second microcomputer 123 (or 123A) is mutually communicated with the first microcomputer 115 of the STB 101 so as to firstly confirm a connection between the STB 101 and the display apparatus 102 (or 102A). Then, when the first microcomputer 115 and the second microcomputer 123 (or 123A) have mutually confirmed the connection, the first microcomputer 115 requests to acquire the ID information with respect to the second microcomputer 123 (or 123A). When the second microcomputer 123 (123A) receives the ID information request command from the first microcomputer 115, the second microcomputer 123 (or 123A) transmits the ID information which has been previously stored in the memory 125 via the communication line contained in the cable 103 to the first microcomputer 115 of the STB 101. The first microcomputer 115 receives the transmitted ID information, and analyzes the received ID information so as to judge a sort and a display format (technical specification) of a display device employed in the display apparatus 102 (or 102A) connected to the STB 101, information for indicating whether or not an image quality correcting circuit is provided, information for indicating whether or not an OSD circuit is provided, and the like, so that the first microcomputer 115 can cause the display apparatus 102 (or 102A) to be operated under optimum condition.

As previously described, in accordance with the arrangements of the display systems related to the first and second embodiments, the STB 101 can be properly operated in correspondence with such a case that sorts and technical specifications of display devices such as a liquid crystal display panel and a PDP are different from each other, and information for indicating whether or not an image quality correcting circuit and an OSD circuit are provided. In other words, the STB 101 can be operated under optimum condition in correspondence with the sort and the technical specification of the display device employed in the display panel of the display apparatus, the information for indicating whether or not the image quality correcting circuit is provided, and also, the information for indicating whether or not the OSD circuit is provided. As a result, the STB 101 can be commonly utilized irrespective of the different sorts and technical specifications of the display devices employed in the display apparatus 102 (102A), and the STB 101 can be arbitrarily combined with the display device provided in the display apparatus 102 (or 102A), so that a variety of choices made by users can be widened, and thus, a user friendly characteristic can be improved. In addition, after a user has purchased such a display system arranged by an STB and, for example, a liquid crystal display apparatus, in the case that the user wants to view moving pictures by operating a display apparatus equipped with another display device which is different from the above-described liquid crystal display apparatus, the user may merely purchase only the second-mentioned different display apparatus. As a result, economical costs shared by the user can be reduced.

Apparently, it should also be understood that with respect to the motion compensating type frame rate conversion, other frame rate converting methods than the above-described frame rate converting method may be alternatively applied. In the above-described first and second embodiments, such a case that the frame rates of the inputted moving picture signals are 50 Hz and 24 Hz has been exemplified. As apparent from the foregoing description, moving picture signals having other frame rates than 24 Hz and 50 Hz may be alternatively employed. In accordance with the above-explained arrangements, the signal processing apparatus can be arbitrarily combined with such display apparatuses that the sorts and technical specifications of the display devices employed therein are different from each other, so that the user friendly characteristics of the display systems can be improved. Also, the frame rate of the moving picture signal transmitted from the signal processing apparatus to the display apparatus is approximately 60 Hz at the most. As a result, the spurious radiation (electromagnetic interference) caused by the moving picture signal transmitted from the signal processing apparatus to the display apparatus can be suppressed, and even in such a cable whose transfer speed is limited due to the transfer range characteristic thereof, the moving picture of the transmitted moving picture signal can be displayed in real time mode. More specifically, if as the display panel of the display apparatus, such a display device (for instance, liquid crystal display panel) is employed which can display thereon a moving picture at a frame rate which is “n” times higher than a frame rate of a moving picture signal entered to the display apparatus, while symbol “n” indicates any number other than 0, then a blurring phenomenon (namely, feelings of “after image”) of moving pictures can be reduced which may specifically occur in such a liquid crystal display panel, so that a high image quality can be realized in the liquid crystal display panel.

It should be further understood by those skilled in the art that although the foregoing description has been made on embodiments of the invention, the invention is not limited thereto and various changes and modifications may be made without departing from the spirit of the invention and the scope of the appended claims.

1. A display system comprising:
a signal processing apparatus for receiving a moving picture signal so as to process the received moving picture signal; and
a display apparatus for displaying thereon said moving picture signal processed by said signal processing apparatus;
wherein said signal processing apparatus includes a first frame rate converting unit which generates an interpolated frame based upon motional information of said moving picture signal, and inserts said generated interpolated frame into a frame series of said received moving picture signal so as to convert a frame rate; and
wherein said display apparatus includes a second frame rate converting unit which generates an interpolated frame based upon motional information of said moving picture signal, and inserts said formed interpolated frame into the frame series of said received moving picture signal so as to convert a frame rate.

2. A display system as claimed in claim 1,
wherein said first frame rate converting unit converts the frame rate into a first frame rate; and
wherein said second frame rate converting unit converts the frame rate into a second frame rate which is different from the first frame rate.

3. A display system as claimed in claim 1, wherein said first frame rate is 60 Hz.

4. A display system as claimed in claim 1,
wherein said first frame rate converting unit and/or said second frame rate converting unit generates the interpolated frame in such a manner that a direction of motion of an object contained in the moving picture signal is detected from at least two frames within an original frame contained in said moving picture signal, and an interpolated pixel is formed from pixel data of said two frames which are present on a straight line indicative of said motion.

5. A display system as claimed in claim 1,
wherein said display apparatus comprising:
a second OSD (on-screen display) unit which superimposes an image signal on said moving picture signal;
a storage unit which stores information related to said second OSD unit; and
an output unit which outputs the information related to said second OSD unit stored in said storage unit to said signal processing apparatus;
wherein said moving picture processing apparatus comprising:
a first OSD unit which superimposes an image signal on said moving picture signal;
an input unit which inputs the information related to said second OSD unit from said output unit; and
a control unit; and
wherein said control unit controls said first OSD unit in response to the information related to said second OSD unit inputted by said input unit.

6. A display system as claimed in claim 5, wherein in such a case that the information related to said second OSD unit entered by said input unit is information for indicating that said second OSD unit is present in said display apparatus, said control unit controls said first OSD unit not to superimpose the image signal on said moving picture signal.

7. A display system as claimed in claim 1,
wherein said display apparatus comprising:
a first image adjusting unit which adjusts an image of said moving picture signal;
a storage unit which stores information related to said display apparatus; and
an output unit which outputs the information related to said display apparatus stored in said storage unit to said moving picture processing apparatus;
wherein said moving picture processing apparatus comprising:
a second image adjusting unit which adjusts an image of said moving picture signal; and
an input unit which inputs the information related to said display apparatus outputted from said output unit; and
wherein said control unit controls said first image adjusting unit in response to the information related to said display apparatus entered by said input unit.

8. A display system as claimed in claim 7,
wherein in such a case that the information related to said display apparatus entered by said input unit is information for indicating that both said second frame rate converting unit and said second image adjusting unit are present in said display apparatus, said control unit controls said first image adjusting unit not to adjust an image of said moving picture signal.

9. A display system as claimed in claim 2,
wherein said second frame rate corresponds to a frame rate which is approximately “n” times higher than said first frame rate, while symbol “n” indicates any number other than 0.

10. In a signal processing apparatus for receiving a moving picture signal and for processing the received moving picture signal so as to output the processed moving picture signal to a display apparatus,
a receiving apparatus comprising:
a frame rate converting unit which generates an interpolated frame based upon motional information of said received moving picture signal, and for inserting said formed interpolated frame into a frame series of said moving picture signal so as to convert a frame rate of said received moving picture signal;
an image quality adjusting unit which adjusts an image quality of the moving picture signal, the frame rate of which has been converted by said frame rate;
an OSD unit which superimposes an image signal on the moving picture signal, the image quality of which has been adjusted by said image quality adjusting unit;
an input unit which inputs information related to said display apparatus from said display apparatus; and
a control unit; and
wherein said control unit controls said frame rate converting unit, said image quality adjusting unit, and said OSD unit in response to the information related to said display apparatus entered by said input unit.
